(19) United States
(12) Patent Application Publication
(10) Pub. No.: US 2014/0326566 A1
(43) Pub. Date: Nov. 6, 2014

(54) ONE-WAY CLUTCH WITH CONICAL STRUT

(71) Applicant: Schaeffler Technologies GmbH & Co. KG, Herzogenaurach (DE)

(72) Inventors: Patrick M. Lindemann, Wooster, OH (US); Markus Steinberger, Macedonia, OH (US); Jacob Rufener, Rittman, OH (US)

(73) Assignee: Schaeffler Technologies GmbH & Co. KG, Herzogenaurach (DE)

(21) Appl. No.: 14/259,302

(22) Filed: Apr. 23, 2014

Related U.S. Application Data
(60) Provisional application No. 61/818,614, filed on May 2, 2013.

(51) Int. Cl. F16D 41/069

(52) U.S. Cl. CPC F16D 41/069
USPC 192/45.1

(57) ABSTRACT

A one-way clutch, including: a housing including a top side and a plurality of indentations in the housing, each indentation including: a respective opening in a portion of the top side; a respective bottom wall opposite the respective opening in an axial direction parallel to an axis of rotation for the one-way clutch; and a respective side wall. The respective side wall:

connects the respective opening and the respective bottom wall and tapers inward from the respective opening to the respective bottom wall. The clutch includes a plurality of struts, each strut including a first segment disposed in a respective indentation and including a respective side surface substantially parallel to the respective side wall. Each strut is pivotable in the respective indentation to enable rotation of the housing in a first rotational direction and to block rotation of the housing in a second rotational direction, opposite the first rotational direction.

### CROSS-REFERENCE TO RELATED APPLICATIONS

This application claims the benefit under 35 U.S.C. §119(e) of U.S. Provisional Patent Application No. 61/818,614, filed May 2, 2013, which application is incorporated herein by reference in its entirety.

### TECHNICAL FIELD

The present disclosure relates to a one-way clutch with conical struts, in particular, a one-way clutch for a stator for a torque converter including matingly configured conical struts and indentations for the struts in a housing. The present disclosure also relates to protrusions on the struts, the indentations, or a side plate to minimize drag associated with rotation of the struts in the indentations.

### BACKGROUND

FIG. 9 is a plan view of known stator 200 for a torque converter with a side plate removed.

FIG. 10 is a cross-sectional view generally along line 10-10 in FIG. 9. The following should be viewed in light of FIGS. 9 and 10. Stator 200 includes housing 202 with struts 204 in indentations 206. For rotation of the housing in direction RD2, struts 204 engage stator shaft 208 to block further rotation of the housing in direction RD2. For rotation of the housing in direction RD1, struts 204 slide over the stator shaft, without locking onto the stator shaft, to enable rotation of the housing in direction RD2.

As seen in FIG. 10, struts 204 include respective vertical side surfaces 210 and indentations 206 include respective vertical side walls 212. Both surfaces 210 and walls 212 are parallel to one another and to axis of rotation R for the stator. To attain the parallel configuration of walls 212, an extra step must be performed after the housing is cast. Specifically, the walls must be machined, after the housing is cast, to remove a conical shape of walls 212 necessitated by the casting process (draft angle). The machining step increases the cost, complexity, and time associated with fabrication of housing 202.

### SUMMARY

According to aspects illustrated herein, there is provided a one-way clutch, including: a housing including a top side and a plurality of indentations in the housing, each indentation including: a respective opening in a portion of the top side; a respective bottom wall opposite the respective opening in an axial direction parallel to an axis of rotation for the one-way clutch; and a respective side wall. The respective side wall: connects the respective opening and the respective bottom wall and tapers inward from the respective opening to the respective bottom wall. The clutch includes a plurality of struts, each strut including a first segment disposed in a respective indentation and including a respective side surface substantially parallel to the respective side wall. Each strut is pivotable in the respective indentation to enable rotation of the housing in a first rotational direction and to block rotation of the housing in a second rotational direction, opposite the first rotational direction.

According to aspects illustrated herein, there is provided a stator for a torque converter, including: a housing including a top side and a one-way clutch including: a plurality of indentations in the housing, each indentation including a respective opening in a portion of the top side, a respective bottom wall opposite the respective opening in an axial direction parallel to an axis of rotation for the stator, and a respective side wall. Each side wall connects the respective opening and the respective bottom wall and tapers inward from the respective opening to the respective bottom wall. The stator includes plurality of struts, each strut including a first segment disposed in a respective indentation and including a respective side surface substantially parallel to the respective side wall. Each strut is pivotable in the respective indentation to enable rotation of the housing in a first rotational direction and to block rotation of the housing in a second rotational direction, opposite the first rotational direction.

According to aspects illustrated herein, there is provided a one-way clutch, including: a housing including a top side; a side plate including a bottom side engaged with the top side; and a plurality of indentations in the housing, each indentation including a respective opening in the top side, a respective bottom wall opposite the respective opening in an axial direction parallel to an axis of rotation for the one-way clutch, and a respective side wall. The side wall connects the respective opening and the respective bottom wall and tapers inward from the respective opening to the respective bottom wall. The clutch includes a plurality of struts, each strut including a respective first segment disposed in a respective indentation, the respective first segment including a respective side surface substantially parallel to the respective side wall a respective top surface facing the respective opening, and a respective bottom surface facing the respective bottom wall. The bottom side of the side plate covers the plurality of indentations. The side plate includes a plurality of protrusions, each protrusion aligned, in the axial direction, with a respective strut in a respective indentation and extending toward the respective strut in the respective indentation, or each strut includes a respective protrusion extending from the respective top surface toward the side plate; or, the respective bottom surface for said each strut includes a respective protrusion extending toward the respective bottom wall of a respective indentation, or the respective bottom wall for said each indentation includes a respective protrusion extending toward the respective bottom surface of a respective strut.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is plan view of a one-way clutch with conical struts and with a side plate removed;

FIG. 3 is a partial cross-sectional view generally along line 3-3 in FIG. 2, with a side plate included;

FIG. 4 is a partial cross-sectional view generally along line 4-4 in FIG. 2, with a side plate included;

FIG. 5 is a partial cross-sectional view generally along line 5-5 in FIG. 2, with a side plate included;

FIG. 6 is a partial cross-sectional view generally along line 6-6 in FIG. 2, with a side plate included;

FIG. 7 is a perspective view of the strut in FIGS. 3 and 5;

FIG. 8 is a side view of the strut in FIG. 7;

FIG. 9 is a plan view of a known stator for a torque converter with a side plate removed; and,

FIG. 10 is a cross-sectional view generally along line 10-10 in FIG. 9.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

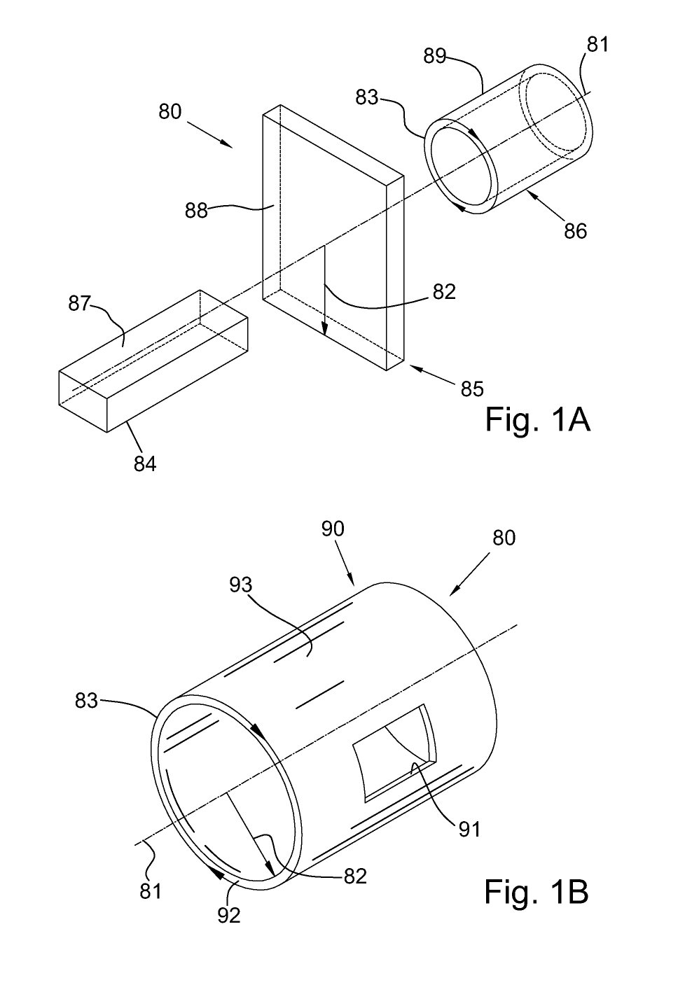

FIG. 1A is a perspective view of cylindrical coordinate system 80 demonstrating spatial terminology used in the present application. The present disclosure is at least partially cast within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is a circumferential surface.

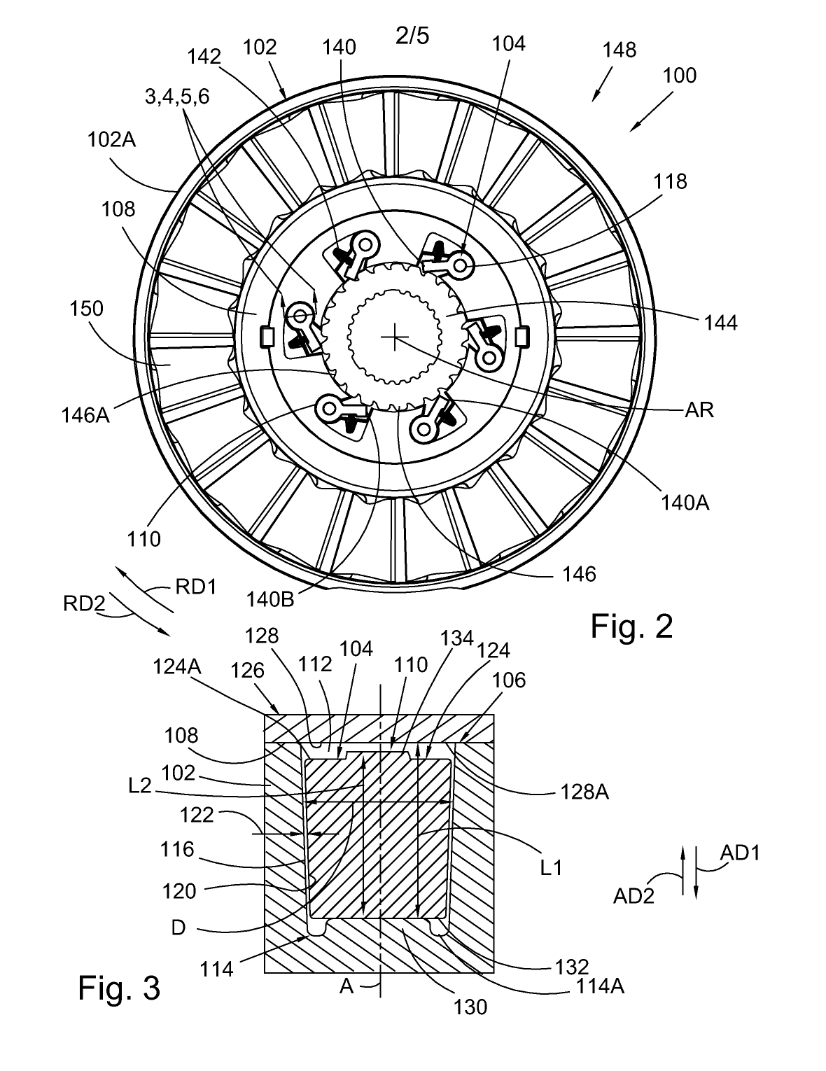

FIG. 2 is plan view of one-way clutch 100 with conical struts and with a side plate removed.

FIG. 3 is a partial cross-sectional view generally along line 3-3 in FIG. 2, with a side plate included. The following should be viewed in light of FIGS. 2 and 3. One-way clutch 100 includes housing 102 and struts 104. Housing 102 includes top side 106 including portion 108 substantially orthogonal to axis of rotation AR for the stator. Clutch 100 includes indentations 110 in portion 108. Each indentation includes opening 112 in portion 108, bottom wall 114 opposite opening 112 in axial direction AD1 parallel to axis of rotation AR, and respective side wall 116. Side wall 116 connects opening 112 and the respective bottom wall 114, tapers inwardly, that is, in a cone shape, from opening 112 to bottom wall 114. For example, diameter D of side wall 116 (with respect to axis A parallel to axis AR) diminishes as the point of measurement for D moves in direction AD1. In a cross-section orthogonal to axis A, for example the configuration shown in FIG. 2, side wall 116 forms a portion of a circle.

Each strut 104 includes segment 118 disposed in a respective indentation 110. Segment 118 includes side surface 120 substantially parallel to side wall 116. That is, surface 120 has a taper paralleling the taper of side wall 116. In a cross-section orthogonal to axis A, for example the configuration shown in FIG. 2, segment 118 forms a portion of a circular disc. Gap 122 is present between side surface 120 and side wall 116 to enable pivoting of strut 104 about axis A while in indentation 110. Gap 122 is exaggerated for purposes of illustration. Each strut 104 is pivotable in a respective indentation 110 to enable rotation of the housing in rotational direction RD1 (free-wheel mode) and to block rotation of the housing in a rotational direction RD2 (locking mode), as further described below.

Each strut 104 includes top surface 124. One-way clutch 100 includes side plate 126 including bottom side 128 engaged with portion 108 of the top side and covering indentations 110. For example, side 128 is in contact with portion 108 and covers indentations 110. Top surface 124 faces plate 126 in direction AD2.

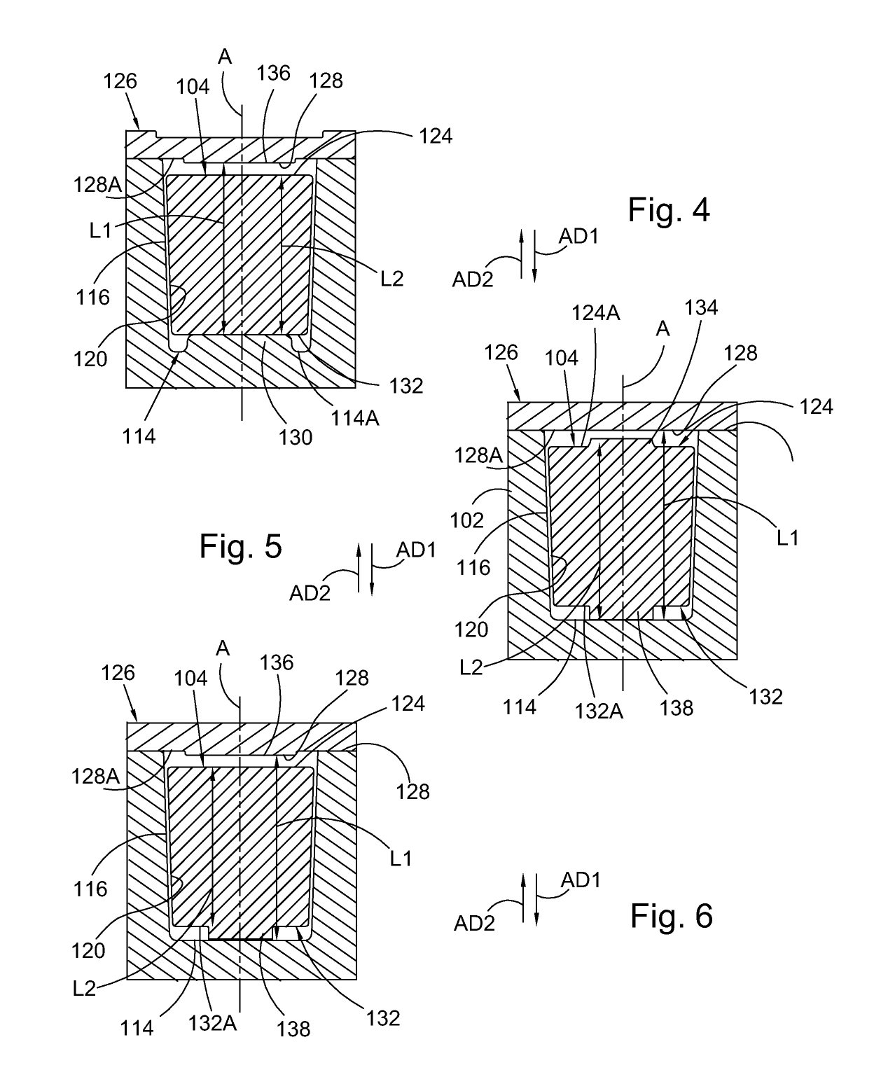

FIG. 4 is a partial cross-sectional view generally along line 4-4 in FIG. 2, with a side plate included. The following should be viewed in light of FIGS. 2 through 4. In an example embodiment, as shown in FIGS. 3 and 4, bottom wall 114 includes protrusion 130 extending from bottom wall 114 toward bottom wall 132 of strut 104. That is, protrusion 130 extends, in direction AD2, from portion 114A of wall 114. As further described below, protrusion 130, having a smaller area than wall 114 as a whole, reduces drag between strut 104 and wall 114 as strut pivots in indentation 110 while protrusion 130 and surface 132 are in contact. In an example embodiment, bottom surface 132 is substantially planar.

FIG. 5 is a partial cross-sectional view generally along line 5-5 in FIG. 2, with a side plate included. The following should be viewed in light of FIGS. 2 through 5. In an example embodiment, as shown in FIGS. 3 and 5, strut 104 includes protrusion 134 extending from top surface 124 toward side plate 126. That is, protrusion 134 extends, in direction AD2, from portion 124A of surface 124. As further described below, protrusion 134, having a smaller area that surface 124 as a whole, reduces drag between strut 104 and side plate 126 as strut pivots in indentation 110 while protrusion 134 and plate 126 are in contact. In an example embodiment, portion 128A of bottom side 128, aligned with indentation 110 in direction AD2, is substantially planar.

FIG. 6 is a partial cross-sectional view generally along line 6-6 in FIG. 2, with a side plate included. The following should be viewed in light of FIGS. 2 through 6. In an example embodiment, for example as shown in FIGS. 4 and 6, plate 126 includes protrusions 136 extending from bottom side 128, in particular, portion 128A. Each protrusion 136 extends toward respective top surface 124 of each strut 104 in direction AD1. As further described below, protrusion 136, having a smaller area that portion 128A as a whole, reduces drag between strut 104 and plate 126 as strut pivots in indentation 110 while protrusions 136 and struts 104 are in contact. In an example embodiment, surface 124 is substantially planar.

In an example embodiment, for example as shown in FIGS. 5 and 6, strut 104 includes protrusion 138 extending from bottom surface 132 toward bottom wall 114. That is, protrusion 138 extends, in direction AD1, from portion 132A of surface 132. As further described below, protrusion 138, having a smaller area that bottom surface 132 as a whole, reduces drag between strut 104 and wall 114 as strut pivots in indentation 110 while strut 104 and wall 114 are in contact. In an example embodiment, wall 114 is substantially planar.

FIG. 3 shows an example configuration with protrusions 130 and 134 in conjunction. FIG. 4 shows an example configuration with protrusions 130 and 134 in conjunction. FIG. 5 shows an example configuration with protrusions 134 and 138 in conjunction. FIG. 6, shows an example configuration with protrusions 136 and 138 in conjunction.

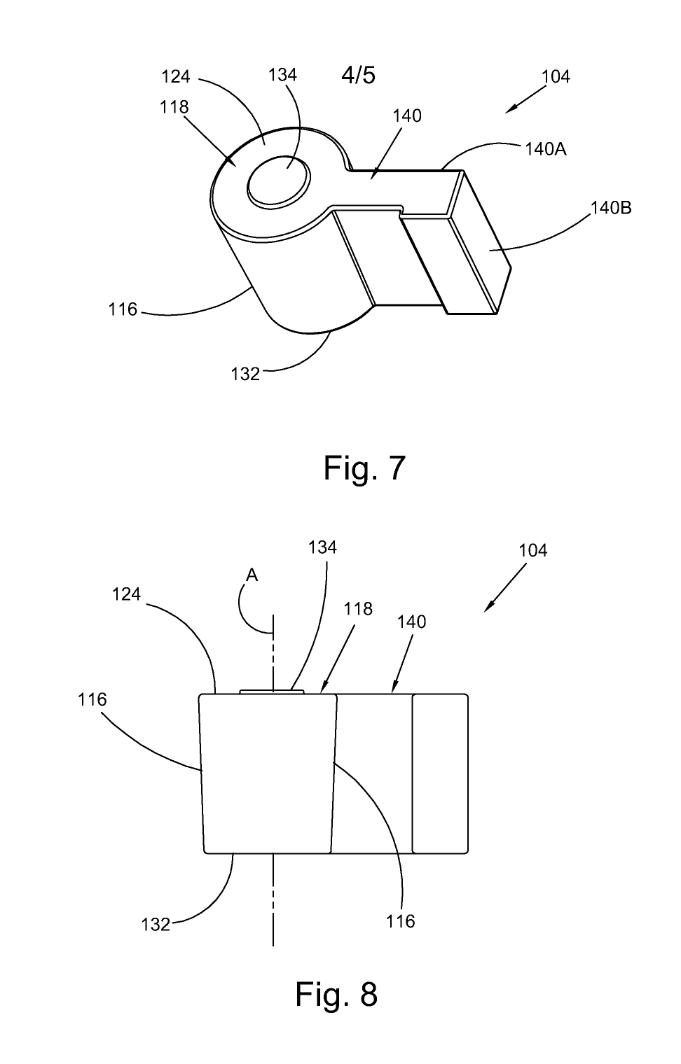

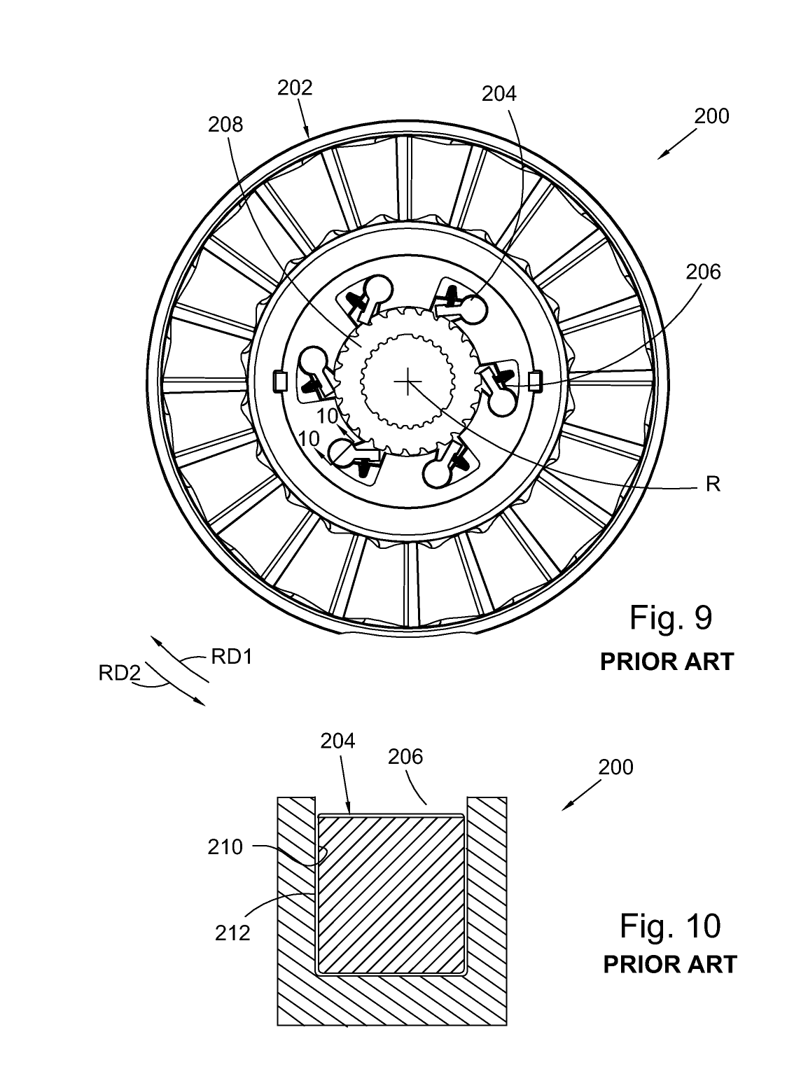

FIG. 7 is a perspective view of strut 104 in FIGS. 3 and 5.

FIG. 8 is a side view of strut 104 in FIG. 7. The following should be viewed in light of FIGS. 2 through 8. In an example embodiment, strut 104 includes segment 140 and resilient elements 142. Segment 140 extends from portion 118. Elements 142 are engaged with segments 140 and urge segments 140 radially inward so that at least some of struts 104 lockingly engage non-rotatable shaft, or inner hub, 144. For the free-wheel mode, for example, rotation of housing 102 in direction RD1, at lower rotational speed, portions 140A of the struts slide across ramps 146 without locking with the ramps. As the rotational speed increases, centrifugal force urges segment 140 radially outward until segments 140 no longer engage ramps 146. In the locking mode, for example, rotation in direction RD2, respective portions 140B of segments 140 for at least some of struts 104 lockingly engage with ramps 146. In particular, portions 140B engage faces 146A to block further rotation of housing 102.

Thus, proper operation of one-way clutch 100 requires that struts 104 be able to pivot as needed to switch between free-wheel and locking modes. In an example embodiment, axial length L1 between plate 126 and wall 114 is greater than axial length L2 of strut 104. When one-way clutch 100 is at rest or is rotating at lower speed in the free-wheel mode, surface 132 may be in contact with wall 114. As noted above, protrusions 130 and 138 advantageously reduce drag when surface 132 and wall 114 are in contact, which facilitates the desired pivoting of strut 104.

As noted above, casting of housing 102 requires a conical shape for walls 120 (draft angle). Advantageously, because side surfaces 116 have a complimentary conical shape, struts 104 can be used in the indentations with the draft angle (conical shape for walls 120) intact. Thus, the step of machining walls 120 to remove the conical shape is not required, reducing the cost, time, and complexity associated with fabricating one-way clutch 100.

However, the complimentary conical shapes of walls 116 and 120 noted above creates a problem that is solved by the use of protrusions 134 and 136. Namely, force applied to portions 140B causes struts 104 “ride up” sloped wall 116 in reaction to the force. Thus, struts 104 displace in direction AD2 such that top surfaces 124 of the struts are in contact with side 128 of plate 126. The contact of surfaces 124 with side 128 produces drag, which resists the desired motion of struts 124. However, protrusions 134 and 136 advantageously reduce the area of contact between struts 104 and side 128, and hence the drag associated with the contact of struts 104 and 128, overcoming the problem noted above and enabling the desired motion of struts 104.

In an example embodiment, clutch 100 is part of torque converter stator 148 and housing 102 includes radially outer portion 102A and blades 150 connected to outer portion 102A. In example embodiments, clutch 100 is used in: any torque transmitting device known in the art, such as a transmission; a seat adjuster; or a parking brake.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A one-way clutch, comprising:
a housing including a top side;
a plurality of indentations in the housing, each indentation including:
a respective opening in a portion of the top side;
a respective bottom wall opposite the respective opening in an axial direction parallel to an axis of rotation for the one-way clutch; and,
a respective side wall:
connecting the respective opening and the respective bottom wall; and,
tapering inward from the respective opening to the respective bottom wall; and,
a plurality of struts, each strut including a first segment disposed in a respective indentation and including a respective side surface substantially parallel to the respective side wall, wherein:
said each strut is pivotable in the respective indentation to enable rotation of the housing in a first rotational direction and to block rotation of the housing in a second rotational direction, opposite the first rotational direction.

2. The one-way clutch of claim 1, wherein:
said each strut includes a respective top surface facing the respective opening, the one-way clutch further comprising:
a side plate including a bottom side engaged with the portion of the top side and covering the plurality of indentations,
wherein:
the side plate includes a plurality of protrusions, each protrusion:
aligned, in the axial direction, with a respective strut; and,
extending toward a respective strut in the respective indentation; or,
wherein:
said each strut includes a respective protrusion extending from the respective top surface toward the side plate.

3. The one-way clutch of claim 2, wherein:
a gap, in the axial direction, is present between said each protrusion from the plurality of protrusions for the side plate and the respective strut; or,
a gap, in the axial direction, is present between the respective protrusion for said each strut and the side plate.

4. The one-way clutch of claim 1, wherein:
said each strut includes a respective bottom surface facing the respective bottom wall of a respective indentation; and,
the respective bottom surface includes a respective protrusion extending toward the respective bottom wall; or,
wherein the respective bottom wall includes a respective protrusion extending toward the respective bottom surface of a respective strut.

5. The one-way clutch of claim 4, further comprising:
a side plate including a bottom side engaged with the surface and covering the plurality of indentations, wherein:
a gap, in the axial direction, is present between said each strut and the side plate.

6. The one-way clutch of claim 1, wherein:
said each strut includes a respective second segment extending from the respective first segment;
the one-way clutch includes a plurality of resilient elements;
each resilient element is engaged with the respective second segment for a respective strut from the plurality of struts;
said each resilient element urges the respective second segment radially inward; and,
the respective second segment is arranged to engage a stator shaft to block rotation of the stator housing in the second rotational direction.

7. The one-way clutch of claim 1, wherein the respective side walls form respective partial circles in a cross-section orthogonal to the axis of rotation for the one-way clutch.

8. The one-way clutch of claim 1, wherein the respective first segments form respective partial circular discs in a cross-section orthogonal to the axis of rotation for the one-way clutch.

9. A stator for a torque converter, comprising:
a housing including a top side; and,
a one-way clutch including:
a plurality of indentations in the housing, each indentation including:
a respective opening in a portion of the top side;
a respective bottom wall opposite the respective opening in an axial direction parallel to an axis of rotation for the stator; and,
a respective side wall:
connecting the respective opening and the respective bottom wall; and,
tapering inward from the respective opening to the respective bottom wall; and,
a plurality of struts, each strut including a first segment disposed in a respective indentation and including a respective side surface substantially parallel to the respective side wall, wherein:
said each strut is pivotable in the respective indentation to enable rotation of the housing in a first rotational direction and to block rotation of the housing in a second rotational direction, opposite the first rotational direction.

10. The stator of claim 9, wherein:
said each strut includes a respective top surface facing the respective opening, the stator further comprising:
a side plate including a bottom side engaged with the portion of the top side and covering the plurality of indentations,
wherein:
the side plate includes a plurality of protrusions, each protrusion:
aligned, in the axial direction, with a respective strut; and,
extending toward a respective strut in the respective indentation; or,
wherein:
said each strut includes a respective protrusion extending from the respective top surface toward the side plate.

11. The stator of claim 10, wherein:
a gap, in the axial direction, is present between said each protrusion from the plurality of protrusions for the side plate and the respective strut; or,
a gap, in the axial direction, is present between the respective protrusion for said each strut and the side plate.

12. The stator of claim 9, wherein:
said each strut includes a respective bottom surface facing the respective bottom wall of a respective indentation; and,
the respective bottom surface includes a respective protrusion extending toward the respective bottom wall; or,
wherein the respective bottom wall includes a respective protrusion extending toward the respective bottom surface of a respective strut.

13. The stator of claim 12, further comprising:
a side plate including a bottom side engaged with the surface and covering the plurality of indentations, wherein:
a gap, in the axial direction, is present between said each strut and the side plate.

14. The stator of claim 8, wherein:
said each strut includes a respective second segment extending from the respective first segment;
the one-way clutch includes a plurality of resilient elements;
each resilient element is engaged with the respective second segment for a respective strut from the plurality of struts;
said each resilient element urges the respective second segment radially inward; and,
the respective second segment is arranged to engage a stator shaft to block rotation of the stator housing in the second rotational direction.

15. The stator of claim 9, wherein the housing includes:
a radially outer portion; and,
a plurality of blades connected to the radially outer portion.

16. The stator of claim 9, wherein with the portion of the top side is substantially orthogonal to the axis of rotation for the stator.

17. A one-way clutch, comprising:
a housing including a top side;
a side plate including a bottom side engaged with the top side;
a plurality of indentations in the housing, each indentation including:
a respective opening in the top side;
a respective bottom wall opposite the respective opening in an axial direction parallel to an axis of rotation for the One-way clutch; and,
a respective side wall:
connecting the respective opening and the respective bottom wall; and,
tapering inward from the respective opening to the respective bottom wall; and,
a plurality of struts, each strut including a respective first segment disposed in a respective indentation, the respective first segment including:
a respective side surface substantially parallel to the respective side wall;
a respective top surface facing the respective opening; and,
a respective bottom surface facing the respective bottom wall,
wherein:
the bottom side of the side plate covers the plurality of indentations; and,
wherein:
the side plate includes a plurality of protrusions, each protrusion:
aligned, in the axial direction, with a respective strut in a respective indentation; and,
extending toward the respective strut in the respective indentation; or,
said each strut includes a respective protrusion extending from the respective top surface toward the side plate; or,
wherein:
the respective bottom surface for said each strut includes a respective protrusion extending toward the respective bottom wall of a respective indentation; or,
the respective bottom wall for said each indentation includes a respective protrusion extending toward the respective bottom surface of a respective strut.

18. The one-way clutch of claim 17, wherein:
a gap, in the axial direction, is present between said each strut and the side plate.

19. The one-way clutch of claim 17, wherein:
said each strut includes a respective second segment extending from the respective first segment;
the one-way clutch includes a plurality of resilient elements;
each resilient element is engaged with the respective second segment for a respective strut from the plurality of struts;
said each resilient element urges the respective second segment radially inward; and,
the respective second segment is arranged to engage a stator shaft to block rotation of the stator housing in the second rotational direction.

20. The one-way clutch of claim 17, wherein the housing includes:
a radially outer portion; and,
a plurality of blades connected to the radially outer portion.
